(19) United States
(12) Patent Application Publication
(10) Pub. No.: US 2019/0257982 A1
(43) Pub. Date: Aug. 22, 2019

(54) FINE STRUCTURE, METHOD FOR MANUFACTURING THE SAME, AND OPTICAL INSTRUMENT

(71) Applicant: Dexerials Corporation, Tokyo (JP)

(72) Inventor: Masahiro Oowada, Tokyo (JP)

(73) Assignee: Dexerials Corporation, Tokyo (JP)

(21) Appl. No.: 16/277,001

(22) Filed: Feb. 15, 2019

(30) Foreign Application Priority Data
Feb. 19, 2018 (JP) 2018-026748

(51) Int. Cl. G02B 1/18; G02B 1/11

(52) U.S. Cl. CPC G02B 1/18; C03C 2217/76; G02B 1/11

(57) ABSTRACT

Provided are a fine structure which has water resistance, moisture resistance, and an antifouling property and achieves improvement in long-term reliability, a method for manufacturing the fine structure, and an optical instrument. A fine structure 1 includes: an element 2 having a lattice 12 formed at a pitch shorter than a wavelength of light in a used bandwidth on a transparent substrate 10; and a water-repellent layer 3 that covers a surface of the element 2, in which the water-repellent layer 3 has a silica layer 13 made of silica and a silane coupling layer 14 made of a silane coupling agent, in this order from a side of the element 2.

This application is based on and claims the benefit of priority from Japanese Patent Application No. 2018-26748, filed on 19 Feb. 2018, the content of which is incorporated herein by reference.

### BACKGROUND OF THE INVENTION

### Field of the Invention

The present invention relates to a fine structure, a method for manufacturing the fine structure, and an optical instrument.

### Related Art

In the related art, various fine structures including a water-repellent film are known as a fine structure having water resistance, moisture resistance, and an antifouling property. For example, a technology, in which a forming portion and a non-forming portion of a water-repellent film are provided on a transparent substrate (for example, see Patent Document 1), or a technology, in which an organic water-repellent film is provided on a substrate surface, and a region having a different concentration is formed (for example, see Patent Document 2) are disclosed.

In addition, a product including a layer having water repellency and oil repellency in which a lower layer is made of a polymer having hydrophobic groups and an upper layer is made of a fluorine-containing silane coupling agent is disclosed (for example, see Patent Document 3). According to the product, super water repellency/oil repellency is exhibited.

Patent Document 1: Japanese Patent No. 3367572

Patent Document 2: Japanese Unexamined Patent Application, Publication No. 2015-47832

Patent Document 3: Japanese Unexamined Patent Application, Publication No. 2007-196383

### SUMMARY OF THE INVENTION

However, the technology of Patent Document 1 is achieved by mixing a coating solution for forming the water-repellent film and a solvent in a boundary portion between the forming portion and non-forming portion of the water-repellent film, and thus it is difficult to perform control in a fine pattern.

In addition, the technology in Patent Document 2 has an object to prevent ink from being attached to an ink jet head nozzle and thus is not applied to a water-repellent film in a super water-repellent state in which water droplets do not attached as droplets at all. Therefore, it is not possible to avoid degradation, and thus no long-term reliability is achieved.

In addition, in the technology in Patent Document 3, the organic water-repellent film in which the lower layer is made of the polymer is formed, and thus it is difficult to obtain heat resistance. Therefore, it is not possible to avoid degradation in a case where the film is applied to an optical instrument or the like, and thus no long-term reliability is achieved.

The invention is made with consideration for the foregoing description, and an object thereof is to provide a fine structure which has water resistance, moisture resistance, and an antifouling property and achieves improvement in long-term reliability, a method for manufacturing the fine structure, and an optical instrument.

(1) The invention for achieving the object provides a fine structure (for example, a fine structure 1 to be described below) including: an element (for example, an element 2 to be described below) having a lattice (for example, a lattice 12 to be described below) or irregularity formed at a pitch shorter than a wavelength of light in a used bandwidth on an element main body (for example, a transparent substrate 10 to be described below); and a water-repellent layer (for example, a water-repellent layer 3 to be described below) that covers a surface of the element, in which the water-repellent layer has a silica layer (for example, a silica layer 13 to be described below) made of silica and a silane coupling layer (for example, a silane coupling layer 14 to be described below) made of a silane coupling agent, in this order from a side of the element.

(2) In the fine structure according to (1), super water repellency may be obtained to the extent that a contact angle of water with a surface of the fine structure is 100 degrees or larger and 180 degrees or smaller.

(3) In the fine structure according to (2), super water repellency may be obtained to the extent that the contact angle of water with the surface of the fine structure is 150 degrees or larger.

(4) In the fine structure according to any one of (1) to (3), the silica layer has a thickness of 20 nm or smaller.

(5) In the fine structure according to any one of (1) to (4), the silane coupling layer contains fluorine.

(6) In the fine structure according to any one of (1) to (5), the lattice is configured of the same material as a material of the element main body.

(7) In the fine structure according to any one of (1) to (5), the lattice is configured of a different material from the material of the element main body.

(8) In the fine structure according to any one of (1) to (7), the lattice has a height of 10 nm or larger.

(9) In the fine structure according to any one of (1) to (8), the element has at least one of a polarizing function and an anti-reflection function.

(10) There is provided a method for manufacturing the fine structure according to any one of (1) to (9), the method including: an element forming step of forming an element having a lattice or irregularity at a pitch shorter than a wavelength of visible light; a silica layer forming step of forming a silica layer made of silica on a surface of the element formed by the element forming step; and a silane coupling layer forming step of forming a silane coupling layer made of a silane coupling agent on a surface of the silica layer formed by the silica layer forming step.

(11) In addition, there is provided an optical instrument including the fine structure according to any one of (1) to (9).

According to the invention, it is possible to provide a fine structure which has water resistance, moisture resistance, and an antifouling property and achieves improvement in long-term reliability, a method for manufacturing the fine structure, and an optical instrument.

### BRIEF DESCRIPTION OF THE DRAWINGS

FIG. 1 is a perspective view illustrating a configuration of a fine structure according to an embodiment of the invention.

FIG. 2 is a cross-sectional view illustrating the configuration of the fine structure according to the embodiment.

FIG. 3 is a diagram for illustrating a θ/2 method.

FIG. 4A is a perspective view illustrating a configuration of a fine structure according to Modification Example 1 of the embodiment.

FIG. 4B is a perspective view illustrating a configuration of a fine structure according to Modification Example 2 of the embodiment.

FIG. 4C is a perspective view illustrating a configuration of a fine structure according to Modification Example 3 of the embodiment.

FIG. 4D is a perspective view illustrating a configuration of a fine structure according to Modification Example 4 of the embodiment.

FIG. 4E is a perspective view illustrating a configuration of a fine structure according to Modification Example 5 of the embodiment.

### DETAILED DESCRIPTION OF THE INVENTION

Hereinafter, an embodiment of the invention will be described with reference to the drawings.

### [Fine Structure]

A fine structure according to the embodiment of the invention is obtained by applying the fine structure of the invention to a polarizer. Specifically, the fine structure according to the embodiment is an inorganic polarizer having a wire grid structure, the fine structure including an element having a lattice formed at a pitch shorter than a wavelength of light in a used bandwidth on an element main body and a water-repellent layer that covers a surface of the element.

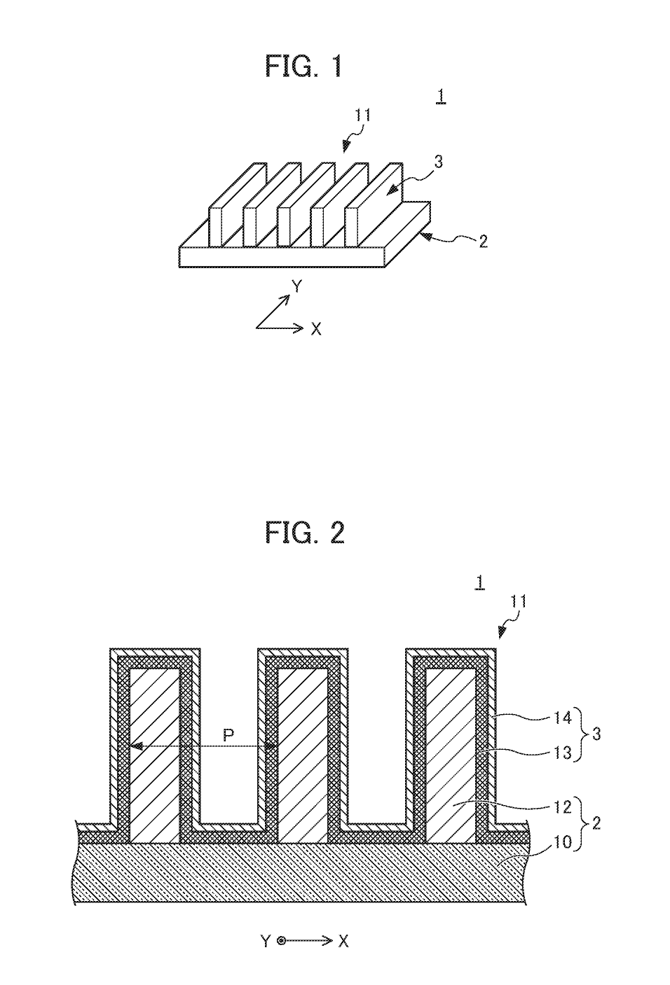

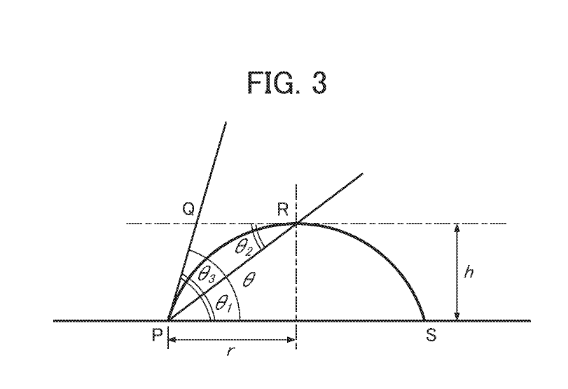

FIG. 1 is a perspective view illustrating a configuration of a fine structure 1 according to the embodiment. FIG. 2 is a cross-sectional view illustrating the configuration of the fine structure 1 according to the embodiment. As illustrated in FIGS. 1 and 2, the fine structure 1 has a wire grid structure 11 and includes an element 2 having a lattice 12 formed at the pitch (cycle) shorter than the wavelength of light in the used bandwidth on a transparent substrate 10 as the element main body and a water-repellent layer 3 that covers a surface of the element 2.

Here, a direction (predetermined direction) in which the lattice 12 is extended as illustrated in FIGS. 1 and 2 is referred to as a Y-axis direction. In addition, a direction orthogonal to the Y-axis direction, in which the lattices 12 are arranged along a main surface of the transparent substrate 10, is referred to as an X-axis direction. In this case, light incident to the fine structure 1 is incident, preferably, from a direction orthogonal to the X-axis direction and the Y-axis direction on a side of the transparent substrate 10 on which the lattice 12 is formed.

The fine structure 1 uses four actions of transmission, reflection, interference, and selective light absorption of a polarized wave due to optical anisotropy, thereby, attenuating a polarized wave (TE wave (S wave)) having an electric field component parallel to the Y-axis direction and transmitting a polarized wave (TM wave (P wave)) having an electric field component parallel to the X-axis direction. Hence, the Y-axis direction is a direction of an absorption axis of the fine structure 1, and the X-axis direction is a direction of a transmission axis of the fine structure 1.

As illustrated in FIG. 2, the element 2 includes the transparent substrate 10 appearing transparent to the light in the used bandwidth and the lattices 12 that are arranged in a one-dimensional shape at the pitch shorter than the wavelength of the light in the used bandwidth on one surface of the transparent substrate 10 and are extended in the predetermined direction.

The transparent substrate 10 is not particularly limited as long as a substrate having transmission of the light in the used bandwidth, and it is possible to appropriately select a substrate according to a purpose.

“Having transmission of the light in the used bandwidth” does not mean that transmittance of the light in the used bandwidth is 100%, and the substrate may have transmission to the extent that the substrate is capable of having a function as the polarizer. For example, the light in the used bandwidth includes visible light having a wavelength of about 380 nm to 810 nm.

A main surface shape of the transparent substrate 10 is not particularly limited, and a shape (for example, a rectangular shape) is appropriately selected according to a purpose. For example, an average thickness of the transparent substrate 10 is preferably 0.3 mm to 1 mm.

As a configurational material of the transparent substrate 10, a material having a refractive index of 1.1 to 2.2 is preferably used, and examples thereof include glass, a quartz crystal, or sapphire. From a viewpoint of costs and light transmittance, it is preferable to use glass, particularly, quartz glass (refractive index of 1.46) or soda-lime glass (refractive index of 1.51). A component composition of a glass material is not particularly limited, and it is possible to use an inexpensive glass material such as silicate glass that is widely distributed as optical glass, for example.

In addition, from a viewpoint of heat conductivity, it is preferable to use a quartz crystal or sapphire having high heat conductivity. Consequently, high lightfastness to intensive light is obtained, and the substrate made of the material described above is preferably used as the polarizer for an optical engine of a projector having a large amount of heat generation.

Incidentally, in a case where the transparent substrate made of an optically active crystal such as the quartz crystal is used, it is preferable to dispose the lattice 12 in a parallel direction or a perpendicular direction to an optical axis of the crystal. Consequently, it is possible to obtain good optical properties. Here, the optical axis is a direction axis on which a minimum difference in refractive index between O (ordinary ray) and E (extraordinary ray) of light traveling in such a direction is obtained.

The lattice 12 is formed into a quadratic pole shape that is perpendicularly extended from the transparent substrate 10. The lattice 12 has a configuration in which a reflective layer, a dielectric layer, and an absorption layer that are all not illustrated are stacked in this order from a side of the transparent substrate 10. In other words, in the fine structure 1 according to the embodiment, the lattice 12 is configured of a different material from the material of the transparent substrate 10 as the element main body.

Therefore, a part of light incident from the side of the fine structure 1, on which the lattice 12 is formed, is absorbed to be attenuated when passing through the absorption layer and the dielectric layer. Of light that is transmitted through the absorption layer and the dielectric layer, the polarized wave (TM wave (P wave)) is transmitted through the reflective layer with high transmittance. On the other hand, of light that is transmitted through the absorption layer and the dielectric layer, the polarized wave (TE wave (S wave)) is reflected from the reflective layer. A part of the TE wave reflected from the reflective layer is absorbed when passing through the absorption layer and the dielectric layer, and a part thereof returns to the reflective layer. In addition, the TE wave reflected from the reflective layer is interfered to be attenuated when passing through the absorption layer and the dielectric layer. As described above, in the fine structure 1, the TE wave is selectively attenuated, and thereby it is possible to obtain a desired polarization property.

Here, the height of the lattice 12 means a dimension in a direction perpendicular to the main surface of the transparent substrate 10, and a width of the lattice 12 means a dimension in the X-axis direction orthogonal to a height direction when viewed from the Y-axis direction parallel to the direction in which the lattice 12 is extended. In addition, when the fine structure 1 is viewed from the Y-axis direction parallel to the direction in which the lattice 12 is extended, a repeated interval in the lattice 12 in the X-axis direction is referred to as a pitch P.

The height of the lattice 12 is preferably 10 nm or longer. The height of the lattice 12 is 10 nm or longer, and thereby super water repellency is more reliably exhibited when the desired optical properties are obtained. It is possible to measure the height of the lattice 12 through observation by a scanning electron microscope or a transmission electron microscope. For example, it is possible to measure heights of the lattice 12 at any four positions by using the scanning electron microscope or the transmission electron microscope and set an arithmetic mean value as the height of the lattice 12. Hereinafter, such a measurement method is referred to as electron microscopy.

The width of the lattice 12 is preferably 35 to 45 nm. The width of the lattice 12 is set in such a range, and thereby super water repellency is more reliably exhibited when the desired optical properties are obtained. For example, it is possible to measure the width of the lattice 12 by the electron microscopy described above.

The pitch P of the lattice 12 is not particularly limited as long as the pitch is shorter than the wavelength of the light in the used bandwidth. From the viewpoint of easiness and stability of preparation, the pitch P of the lattice 12 is preferably 200 nm or smaller, for example. The pitch P of the lattice 12 is set in such a range, and thereby super water repellency is more reliably exhibited when the desired optical properties are obtained. For example, it is possible to measure the pitch P of the lattice 12 by the electron microscopy described above.

The reflective layer is configured of a metal film that is extended in a strip shape in the Y-axis direction, which is the absorption axis. The reflective layer attenuates the polarized wave (TE wave (S wave)) having an electric field component in a direction parallel to a longitudinal direction of the reflective layer and transmits the polarized wave (TM wave (P wave)) having an electric field component in a direction orthogonal to the longitudinal direction of the reflective layer. A configurational material of the reflective layer is not particularly limited as the material has reflectiveness with respect to the light in the used bandwidth, and examples thereof include a single element such as Al, Ag, Cu, Mo, Cr, Ti, Ni, W, Fe, Si, Ge, or Te or an alloy containing one or more elements thereof. Of the materials, it is preferable that the reflective layer is configured of aluminum or an aluminum alloy. Incidentally, the reflective layer may be configured of an inorganic layer or a resin layer other than a metal layer, a surface of the inorganic layer or the resin layer being formed to have high reflectance by being colored or the like other than the metallic materials.

The dielectric layer is formed on the reflective layer and has dielectric films arranged to be extended in a strip shape in the Y-axis direction, which is the absorption axis. Examples of materials for configuring the dielectric layer include Si oxide such as SiO₂, metal oxide such as Al₂O₃, beryllium oxide, or bismuth oxide, or a common material such as MgF₂, cryolite, germanium, titanium dioxide, silicon, magnesium fluoride, boron nitride, boron oxide, tantalum oxide, carbon, or a combination thereof. Of the materials, it is preferable that the dielectric layer is configured of Si oxide.

The absorption layers are formed on the dielectric layer and are arranged to be extended in a strip shape in the Y-axis direction, which is the absorption axis. A configurational material of the absorption layer includes one or more types of substance such as a metallic material or a semiconductor material having a light absorbing action, of which an extinction constant of an optical constant is not zero, and is appropriately selected depending on a wavelength range of the light to be applied. Examples of metallic materials include a single element such as Ta, Al, Ag, Cu, Au, Mo, Cr, Ti, W, Ni, Fe, or Sn or an alloy containing one or more elements thereof. In addition, examples of semiconductor materials include Si, Ge, Te, ZnO, or a silicide material (β-FeSi₂, MgSi₂, NiSi₂, BaSi₂, CrSi₂, CoSi₂, or TaSi). By using the materials, the fine structure 1 obtains a high extinction ratio with respect to a visible light range to be applied. Of the materials, it is preferable that the absorption layer is configured to contain Fe or Ta and to contain Si.

The water-repellent layer 3 has a silica layer 13 made of silica and a silane coupling layer 14 made of a silane coupling agent, in this order from a side of the element 2.

The silica layer 13 is configured of silica. As illustrated in FIG. 2, the silica layer 13 is formed to cover the entire surface of the element 2. Silanol groups are present on the surface of the silica layer 13 and are combined through a condensation reaction with the silane coupling agent in the silane coupling layer 14 to be described below, which is stacked to cover the surface of the silica layer 13. Consequently, the silane coupling layer 14 is strongly combined with the silica layer 13. As a result, it is possible to prevent the silane coupling layer 14 from peeling away. Hence, the fine structure 1 according to the embodiment is to be capable of maintaining good water resistance, moisture resistance, and antifouling property in a long period.

The silica layer 13 may be thin to the extent that a fine structure is not disturbed by coating. A thickness of the silica layer 13 is preferably 1/10 or less than the pitch P (that is, 20 nm or smaller in a case where the pitch P is 200 nm or smaller). Incidentally, it is possible to form the silica layer 13 by using chemical vapor deposition (CVD) or atomic layer deposition (ALD), for example.

The silane coupling layer 14 is configured of the silane coupling agent. As illustrated in FIG. 2, the silane coupling layer 14 is formed to cover the entire surface of the silica layer 13. As described above, the silane coupling agent that configures the silane coupling layer 14 is strongly combined through the condensation reaction with the silanol groups present in the surface of the silica layer 13.

In terms of water repellency/oil repellency, the silane coupling layer 14 is configured of a substance having, preferably, an alkyl chain with a long chain length or, more preferably, an alkyl chain substituted with an atom such as fluorine. More specifically, it is preferable that the silane coupling layer 14 is configured of octadecyltrichlorosilane (OTS) or the like, in addition to a fluorine-based silane coupling agent such as perfluorodecyltriethoxysilane (FDTS). Consequently, better water resistance, moisture resistance, and antifouling property are obtained in a long period. Incidentally, the silane coupling layer 14 can be formed by using dipping or the like, in addition to the CVD or the ALD described above, for example.

Here, the fine structure 1 according to the embodiment has the super water repellency to the extent that a contact angle (water-repellent angle) of water with the surface of the fine structure is 100 degrees or larger. Consequently, the fine structure 1 according to the embodiment has good water resistance, moisture resistance, and antifouling property. It is preferable that the super water repellency in the embodiment is obtained to the extent that the contact angle of water with the surface is 100 degrees or larger and 180 degrees or smaller. For example, the super water repellency increases as the contact angle of water with the surface approximates to 180 degrees, and a super water-repellent state in the embodiment also includes a super water-repellent state in which water droplets cannot be attached to the surface during the measurement of the contact angle (the water droplets are not attached to the surface of the fine structure 1 from a distal end of a nozzle of a contact angle measuring machine), and the contact angle is 150 degrees or larger.

It is possible to measure the contact angle of water with the surface of the fine structure 1 according to the embodiment by the following measurement conditions.

### [Contact Angle Measurement Conditions]

Measuring instrument: Contact angle measuring machine “DM-501” manufactured by Kyowa Interface Science Co., Ltd. Analysis software: FAMAS (image processing method)

### Analysis Method: θ/2 Method

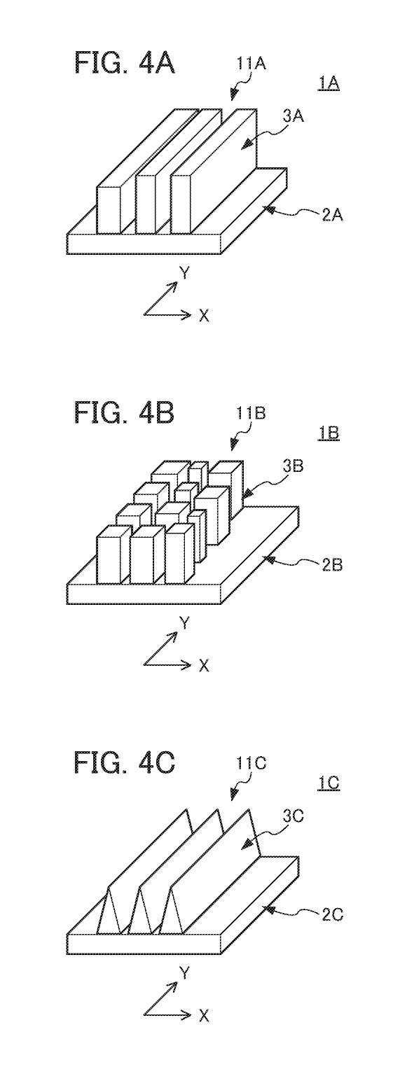

Here, the θ/2 method is described. FIG. 3 is a diagram for describing the θ/2 method, and a diagram schematically illustrating a water droplet on a certain surface. As illustrated in FIG. 3, in the θ/2 method, a part of the water droplet is assumed as a part of an arc. Then, since θ1=θ2 (PS//QR), and θ2=θ3 (PQ=QR), θ1=θ3, and thus a relationship of tan θ1=h/r is achieved. Hence, a contact angle θ of the water droplet as the sum of θ1 and θ3 can be represented by θ=2 arctan h/r, and thereby it is possible to obtain the contact angle θ of the water droplet.

Incidentally, the fine structure 1 according to the embodiment has high oil repellency, in addition to the super water repellency described above. Consequently, the fine structure 1 according to the embodiment has good oil resistance and antifouling property. Similar to the super water repellency, the oil repellency can be evaluated by measuring a contact angle of oil (for example, oleic acid (CH₃(CH₂)₇CH═CH(CH₂)₇COOH)) with a surface in accordance with the measurement conditions described above.

The super water repellency of the surface of the fine structure 1 according to the embodiment having the configuration described above will be described below in more detail based on verification results. First, in the fine structure 1 having the configuration described above, the contact angle of water with the surface was measured in accordance with the measurement conditions described above. As a result, the water droplets were found not to be attached to the surface. In other words, the fine structure 1 according to the embodiment was confirmed that the surface has the super water repellency. Accordingly, it was confirmed that it is possible to apply the structure to various surfaces that need to have the water repellency, and thereby it is possible to realize a surface having high water repellency.

Here, the measurement of the contact angle of water with a surface was performed on a product obtained by forming the silica layer and the silane coupling layer, similarly to the embodiment, in this order on a flat glass substrate that does not have the fine structure such as a lattice structure in the fine structure 1 according to the embodiment, in accordance with the measurement conditions described above. As a result, attachment of the water droplets to the surface was confirmed, and the contact angle thereof was found to be 105 degrees. As a result, the silica layer and the silane coupling layer were formed in this order from the side of the element on a fine structure having a fine structure on a surface thereof similarly to the embodiment, and thereby the super water repellency was first checked to be exhibited.

In other words, since the fine structure 1 according to the embodiment is provided, and thereby, a contact angle of 105 degrees or larger is formed to be larger than a contact angle with a flat surface having at least the same layer structure, and the water droplets cannot be attached to the fine structure 1, a large contact angle in a range of 180° or smaller is formed, and thus the super water repellency is obtained.

Here, the following Table 1 shows a relationship between presence or absence of the silica layer and a water-repellent angle when the fine structure is immersed in pure water for four hours at 90° C. and a relationship between presence or absence of the silica layer and a water-repellent angle when the fine structure stays in the atmosphere for 24 hours at a high temperature of 350° C. In other words, a change in the water-repellent angle between a case where the silica layer is present (case where the silane coupling layer is formed on the silica layer) and a case where the silica layer is absent (case where the silane coupling layer is formed without providing the silica layer) is shown.

TABLE 1

| | | After immersion in | After staying in |
|---|---|---|---|
| | | pure water for four | atmosphere for 24 |
| | Initial | hours at 90° C. | hours at 350° C. |
| Presence of | Unattachable | Unattachable | Unattachable |
| silica layer | | | |
| Absence of | Unattachable | 133.3 degrees | 11.3 degrees |
| silica layer | | | |

In a case where the silane coupling layer is formed in the fine structure that does not have the silica layer, the super water repellency is confirmed to be exhibited in a water-droplet unattachable state in which the water droplets are not attached to the surface in an initial state thereof. However, as shown in Table 1, when the fine structure was immersed in the pure water at 90° C. or stayed in the atmosphere at the high temperature of 350° C. or more, water-repellent performance was found to be significantly different depending on the presence or absence of the silica layer. Specifically, no change is found in the water droplet unattachable state in a case where the silica layer is present; however, the water-repellent angle is confirmed to be significantly decreased in a case where the silica layer is not provided, and the water-repellent performance was found to be significantly degraded. As a result, the silica layer and the silane coupling layer were formed in this order from the side of the element on the fine structure having the fine structure on the surface thereof similarly to the embodiment, and thereby the super water repellency was confirmed to be maintained.

Next, the oil repellency of the surface of the fine structure 1 according to the embodiment will be described below based on verification results. First, in the fine structure 1 having the configuration described above, the contact angle of oil (oleic acid (CH₃(CH₂)₇CH═CH(CH₂)—COOH)) with a surface was measured in accordance with the measurement conditions described above. As a result, attachment of oil droplets to the surface was observed, a contact angle of an oil droplet was 133.7 degrees when viewed from a direction (Y direction in FIG. 1) in which the lattice 12 is extended, and a contact angle of an oil droplet was 105.4 degrees when viewed from a direction (X direction in FIG. 1) orthogonal to the direction in which the lattice 12 is extended. In other words, both of the contact angles were 100 degrees or larger, and thus it was found that no capillary phenomenon was observed.

### [Method for Manufacturing Fine Structure Body 1]

A method for manufacturing the fine structure 1 according to the embodiment includes an element forming step, a silica layer forming step, and a silane coupling layer forming step.

In the element forming step, an element having a lattice or irregularity at a pitch shorter than a wavelength of visible light is formed. For example, in the case of the polarizer, the element forming step includes a reflective layer forming step, a dielectric layer forming step, an absorption layer forming step, and an etching step. In the reflective layer forming step, the reflective layer is formed on the transparent substrate 10 as the element main body. In the dielectric layer forming step, the dielectric layer is formed on the reflective layer formed in the reflective layer forming step. In the absorption layer forming step, the absorption layer is formed on the dielectric layer formed in the dielectric layer forming step. In the layer forming steps, it is possible to form the layers by a sputtering method or a vapor-deposition method, for example.

In the etching step, for example, in the case of the polarizer, a stacked body formed through the layer forming steps described above is selectively etched, and thereby the lattices 12 are formed to be arranged on the transparent substrate 10 at the pitch shorter than the wavelength of the light in the used bandwidth. Specifically, a mask pattern having a one-dimensional lattice shape is formed by a photolithography method and a nanoimprint method, for example. In this manner, the stacked body is selectively etched, and thereby the lattices 12 are formed to be arranged on the transparent substrate 10 at the pitch shorter than the wavelength of the light in the used bandwidth. An example of the etching method includes a dry etching method using etching gas corresponding to an etching target.

In the silica layer forming step, the silica layer 13 made of silica is formed on the surface of the element formed by the element forming step. Specifically, the silica layer 13 is formed by using the CVD or the ALD described above, for example.

In the silane coupling layer forming step, the silane coupling layer 14 made of a silane coupling agent is formed on the surface of the silica layer 13 formed by the silica layer forming step. Specifically, the silane coupling layer 14 is formed by using dipping or the like, in addition to the CVD or the ALD described above, for example. As described above, the fine structure 1 according to the embodiment is manufactured.

### [Optical Instrument]

An optical instrument according to the embodiment includes the fine structure 1 according to the embodiment described above. Examples of the optical instrument include a liquid crystal projector, a head-up display, or a digital camera. Since the fine structure 1 according to the embodiment is the inorganic polarizer having better heat resistance, compared with an organic polarizer, the fine structure is suitable for a use as the liquid crystal projector, the head-up display, or the like that needs to have the heat resistance.

Incidentally, the invention is not limited to the embodiment described above, and the invention also includes a modification and improvement in a range in which it is possible to achieve the object of the invention.

In the description of the embodiment, an example in which the lattice 12 is configured of the stacked body of the reflective layer, the dielectric layer, and the absorption layer is described; however, the configuration of the lattice is not limited thereto. For example, the lattice 12 may be configured of a single metal such as aluminum. In addition, the lattice 12 may be configured of the same material as that of the transparent substrate 10 such as glass.

In other words, in the embodiment described above, the fine structure 1 is applied to the polarizer; however, the embodiment is not limited thereto. For example, the fine structure may be applied to an anti-reflection plate, an anti-reflection film, or a moth eye film, which have a reflection preventing function. Otherwise, the fine structure may be applied to various mirrors or windows for a printer, a magnetic head, or the like. Incidentally, the moth eye film is a film having a concavity/convexity structure (moth eye structure) in which an average pitch of fine irregularity is a wavelength or smaller (for example, 100 nm to 350 nm) in a visible light bandwidth.

In addition, in the embodiment, the fine structure is configured of the one-dimensional lattice as illustrated in FIG. 1 or 2; however, the embodiment is not limited thereto. For example, in the polarizer or the moth eye film, the fine structure may be configured to have various shapes of lattices or irregularities. Hereinafter, an example of the fine structure that configures the fine structure with various shapes of lattices or irregularities. However, in any cases, a configurational material of the water-repellent layer is the same as that of the embodiment described above.

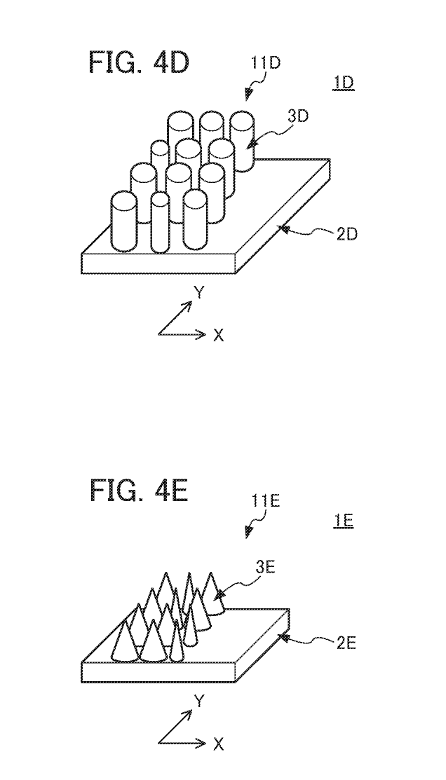

For example, FIG. 4A is a perspective view illustrating a configuration of a fine structure 1A according to Modification Example 1 of the embodiment described above. In the fine structure 1A according to Modification Example 1 illustrated in FIG. 4A, there is described an example in which a fine structure 11A that is formed on an element 2A is configured into a one-dimensional lattice shape in which widths and heights of lattices are different from each other. A water-repellent layer 3A that covers a surface of the element 2A is formed on the element 2A. Additionally, a configuration in which pitch in one-dimensional lattices is different may be employed.

In addition, FIG. 4B is a perspective view illustrating a configuration of a fine structure 1B according to Modification Example 2 of the embodiment described above. In the fine structure 1B according to Modification Example 2 illustrated in FIG. 4B, there is described an example in which a fine structure 11B that is formed on an element 2B is configured to have fine irregularities in which widths and heights of lattices are different from each other. A water-repellent layer 3B that covers a surface of the element 2B is formed on the element 2B.

In addition, FIG. 4C is a perspective view illustrating a configuration of a fine structure 1C according to Modification Example 3 of the embodiment described above. In the fine structure 1C according to Modification Example 3 illustrated in FIG. 4C, there is described an example in which a fine structure 11C that is formed on an element 2C is configured into a one-dimensional lattice shape in which the lattice has a triangular pyramid shape and a cross section thereof, which is orthogonal to a direction in which the lattices are extended, has a triangular shape. A water-repellent layer 3C that covers a surface of the element 2C is formed on the element 2C.

In addition, FIG. 4D is a perspective view illustrating a configuration of a fine structure ID according to Modification Example 4 of the embodiment described above. In the fine structure 1D according to Modification Example 4 illustrated in FIG. 4D, there is described an example in which a fine structure 11D that is formed on an element 2D is configured to have fine irregularities formed by a plurality of circular columns having different diameters or heights from each other. A water-repellent layer 3D that covers a surface of the element 2D is formed on the element 2D.

In addition, FIG. 4E is a perspective view illustrating a configuration of a fine structure 1E according to Modification Example 5 of the embodiment described above. In the fine structure 1E according to Modification Example 5 illustrated in FIG. 4E, there is described an example in which a fine structure 11E that is formed on an element 2E is configured to have fine irregularities formed by a plurality of circular cones having different diameters or heights from each other. A water-repellent layer 3E that covers a surface of the element 2E is formed on the element 2E.

The fine structure bodies according to the modification examples described above all exhibit the same super water repellency as that of the embodiment described above, and thus the same effects as those of the embodiment described above are achieved.

What is claimed is:

1. A fine structure comprising:
an element having a lattice or irregularity formed at a pitch shorter than a wavelength of light in a used bandwidth on an element main body; and
a water-repellent layer that covers a surface of the element, wherein the water-repellent layer has a silica layer made of silica and a silane coupling layer made of a silane coupling agent, in this order from a side of the element.

2. The fine structure according to claim 1,
wherein super water repellency is obtained to the extent that a contact angle of water with a surface of the fine structure is 100 degrees or larger and 180 degrees or smaller.

3. The fine structure according to claim 2,
wherein super water repellency is obtained to the extent that the contact angle of water with the surface of the fine structure is 150 degrees or larger.

4. The fine structure according to claim 1,
wherein the silica layer has a thickness of 20 nm or smaller.

5. The fine structure according to claim 1,
wherein the silane coupling layer contains fluorine.

6. The fine structure according to claim 1,
wherein the lattice is configured of the same material as a material of the element main body.

7. The fine structure according to claim 1,
wherein the lattice is configured of a different material from the material of the element main body.

8. The fine structure according to claim 1,
wherein the lattice has a height of 10 nm or larger.

9. The fine structure according to claim 1,
wherein the element has at least one of a polarizing function and an anti-reflection function.

10. A method for manufacturing the fine structure according to claim 1, the method comprising:
an element forming step of forming an element having a lattice or irregularity at a pitch shorter than a wavelength of visible light;
a silica layer forming step of forming a silica layer made of silica on a surface of the element formed by the element forming step; and
a silane coupling layer forming step of forming a silane coupling layer made of a silane coupling agent on a surface of the silica layer formed by the silica layer forming step.

11. An optical instrument comprising:
the fine structure according to claim 1.
